(19) United States
(12) Patent Application Publication
(10) Pub. No.: US 2021/0071726 A1
(43) Pub. Date: Mar. 11, 2021

(54) FRICTION PLATE AND FRICTION ENGAGEMENT DEVICE PROVIDED WITH THE SAME

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Masaki YOSHIDA, Anjo (JP); Tomoo ATARASHI, Kariya (JP); Junji MATSUSHITA, Anjo (JP); Takuya KOMATSU, Anjo (JP); Yusuke TAKATSUKA, Anjo (JP); Kuniyoshi TAKEDA, Nagoya (JP); Kenichi KIZAWA, Chiryu (JP); Yusuke KOJIMA, Okazaki (JP); Keita IMAI, Seto (JP); Koichi OKUDA, Toyota (JP); Atsushi TABATA, Okazaki (JP); Koji HAYASHI, Nagakute (JP); Kazuyuki SHIIBA, Miyoshi (JP); Hiromichi KIMURA, Okazaki (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 16/644,215

(22) PCT Filed: May 23, 2018
(86) PCT No.: PCT/JP2018/019904

§ 371 Date: Mar. 4, 2020

(30) Foreign Application Priority Data
Sep. 29, 2017 (JP) 2017-191578

(51) Int. Cl. F16D 65/12; F16D 55/40; F16D 69/02

(52) U.S. Cl. CPC F16D 65/127; F16D 2121/04; F16D 69/02; F16D 55/40

(57) ABSTRACT

A friction plate (1₁) includes a plate (1A) with a disc shape and a friction material (F1, F2) that is fixed to aside face (1a) of the plate (1A). The friction material (F1, F2) is disposed so that one or both of an inner peripheral side and an outer peripheral side is nonuniform in an inner and outer peripheral direction with respect to a circumferential direction around a center (CT1) of the plate (1A). Thus, there is an increase in the amount of lubrication oil that is fed to a surface of friction material segments (F1, F2) and there is an increase in a separation force in an axial direction between a friction plate (1₁) and a separator plate or an end plate.

### CROSS REFERENCE TO RELATED APPLICATIONS

This application is a National Stage of International Application No. PCT/JP2018/019904, filed May 23, 2018, claiming priority to Japanese Patent Application No. 2017-191578, filed Sep. 29, 2017, the contents of which are incorporated in their entirety.

### TECHNICAL FIELD

The technique relates to a friction plate that is used for a vehicle driving device and a friction engagement device provided with the friction plate.

### BACKGROUND ART

Conventionally, a friction engagement device such as a wet-type multi-plate clutch or a brake etc. used for a vehicle driving device such as an automatic transmission or a hybrid driving device etc. is lubricated or cooled with lubrication oil to improve durability. However, if the lubrication oil does not enter between the friction plates especially when the friction engagement device is released, the interval between the friction plates is not expanded and a drag torque is generated, which hinders improvement in fuel economy of the vehicle.

There has hitherto been proposed a friction engagement device in which a friction material segment of a friction plate is disposed in two lines consisting of an inner radial side line and an outer radial side line, and a total flow path area of an oil groove on the inner radial side is set to be larger than a total oil passage area of an oil groove on the outer radial side, so that the friction materials are more easily separated (see Patent Document 1). In addition, there has hitherto been proposed a friction engagement device in which minute grooves are formed on the surface of the friction material segment to decrease a fluid shearing resistance and attempt to decrease a drag torque (see Patent Document 2).

### RELATED ART DOCUMENTS

### Patent Documents

Patent Document 1: Japanese Unexamined Patent Application Publication No. 2002-242954 (JP 2002-242954 A)
Patent Document 2: Japanese Unexamined Patent Application Publication No. 2016-23754 (JP 2016-23754 A)

### SUMMARY OF THE DISCLOSURE

### Problem to be Solved by the Various Aspects of the Disclosure

Most of vehicle driving devices such as an automatic transmission etc. is a vehicle driving device that performs a cycle such as scattering the lubrication oil in a case, then allowing the lubrication oil to naturally fall to a lower portion in the case, and suctioning the lubrication oil accumulated in the lower portion by an oil pump to scatter the lubrication oil in the case again. When the friction material is rotated in such a vehicle driving device, the friction material passes through an oil sump formed in the lower part even in the cases of the friction material segments of Patent Document 1 and Patent Document 2 described above. The friction material segment is immersed in the oil sump, which causes the flows of the lubrication oil in the inner and outer peripheral direction to be uniformized and causes the amount of lubrication oil that goes over the friction material segment to be decreased. Thus, there is a possibility that the separation force in the axial direction is decreased and the drag torque is increased.

It is an aspect of the disclosure to provide a friction plate in which it is possible to increase a separation force in an axial direction and attempt to decrease a drag torque and a friction engagement device provided with the friction plate.

### Means for Solving the Problem

A friction plate including:

a plate with a disc shape; and

a friction material that is fixed to a side face of the plate, in which

the friction material is disposed so that one or both of an inner peripheral side and an outer peripheral side are nonuniform in an inner and outer peripheral direction, with respect to a circumferential direction around a center of the plate set.

One or both of the inner peripheral side and the outer peripheral side of the friction material is disposed so as to be nonuniform in the inner and outer peripheral direction. Thus, when an oil sump is stirred or when lubrication oil flowing in from the inner peripheral side is stirred, there is an increase in the amount of lubrication oil that is fed to the surface of the friction material. In addition, there is an increase in the separation force in the axial direction between the inner friction plate and the outer friction plate so that the intervals therebetween can be expanded. It is thus possible to attempt reduction of the drag torque.

### BRIEF DESCRIPTION OF THE DRAWINGS

FIG. 1 illustrates a sectional view of a brake device according to an embodiment.

FIG. 2 is a front view of a friction plate according to a first embodiment.

FIG. 3 is a front view of a friction plate according to a second embodiment.

FIG. 4 is a front view of a friction plate according to a third embodiment.

FIG. 5 is a front view of a friction plate according to a fourth embodiment.

FIG. 6 is a front view of a friction plate according to a fifth embodiment.

FIG. 7 is a front view of a friction plate according to a sixth embodiment.

FIG. 8 is a front view of a friction plate according to a seventh embodiment.

FIG. 9 is a front view of a friction plate according to an eighth embodiment.

FIG. 10 is a front view of a friction plate according to a ninth embodiment.

FIG. 11 is a front view of a friction plate according to a tenth embodiment.

FIG. 12 is a front view of a friction plate according to an eleventh embodiment.

FIG. 13 is a front view of a friction plate according to a twelfth embodiment.

FIG. 14 is a front view of a friction plate according to a thirteenth embodiment.

FIG. 15 is a front view of a friction plate according to a fourteenth embodiment.

FIG. 16 is a front view of a friction plate according to a fifteenth embodiment.

FIG. 17 is a front view of a friction plate according to a sixteenth embodiment.

### DETAILED DESCRIPTION

### First Embodiment

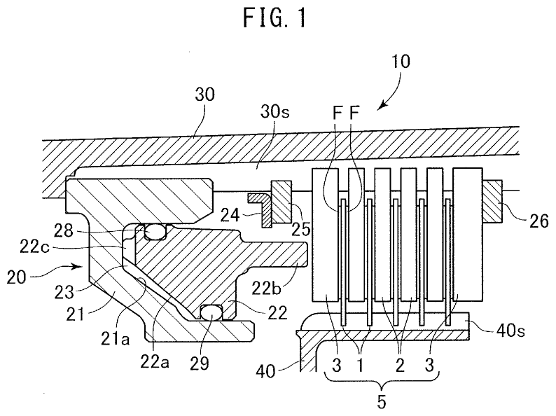

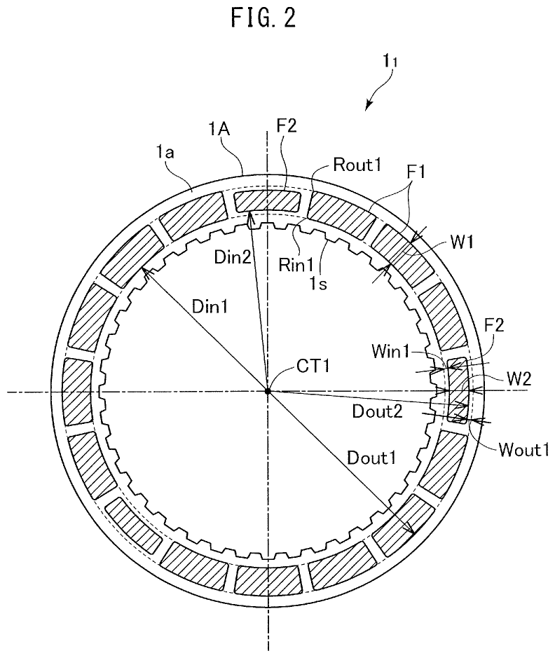

A first embodiment will be described below with reference to FIGS. 1 and 2. FIG. 1 is a sectional view of a braking device according to the first embodiment. FIG. 2 is a front view of a friction plate according the first embodiment.

A braking device 10 according to the embodiment will be described with reference to FIG. 1. The braking device 10 that is a friction engagement device is what is called a wet-type multi-plate clutch. In the braking device 10, an outer friction plate (a separator plate and an end plate) among an inner friction plate (friction plate 1) and the outer friction plate is configured to be spline-engaged with a case 30 serving as a fixed member the rotation of which is fixed, so as to be unrotatable. The braking device 10 is thus configured as a brake that is able to lock the rotation of a rotary member 40 that is spline-engaged with the inner friction plate.

The braking device 10 is installed in a front engine rear drive (FR) type vehicle in which an output shaft of an engine (driving source) faces a vehicle traveling direction. The braking device 10 is provided in a hybrid driving device in which a motor-generator (rotary electric machine) and a speed change mechanism are combined and is used as a brake that establishes shift speeds of the speed change mechanism. However, the braking device 10 is not limited to this, and may be a braking device that is used in a speed change mechanism and a front-reverse switching mechanism in a multi-stage automatic transmission and a continuously variable transmission. As a matter of course, the braking device 10 may be installed in a front engine front drive (FF) type vehicle in which an output shaft of an engine (driving source) is placed transversely with respect to the vehicle traveling direction.

As illustrated in FIG. 1, the braking device 10 is configured to have a friction portion 5 and a hydraulic servo 20 that is configured to press the friction portion 5. The friction portion 5 is configured to have friction plates 1 serving as a plurality of inner friction plates (friction plates) and separator plates 2 and end plates 3 serving as a plurality of outer friction plates, the inner friction plates and the outer friction plates being disposed alternately in an axial direction. Each friction plate 1 is configured so that a spline portion is (see FIG. 2) formed on an inner peripheral side is spline-engaged with a spline portion 40s of the rotary member 40 formed in a hub shape and so as to rotate together and be movable in the axial direction with respect to the rotary member 40. Each separator plate 2 and end plate 3 are spline-engaged with a spline portion 30s formed on an inner peripheral surface of the case 30 in which in a motor-generator or a speed change mechanism not shown is housed, and axial movement of the separator plate 2 and the end plate 3 is restricted by a snap ring 26, that is, the separator plate 2 and the end plate 3 are configured to be movable in the axial direction in a range restricted by the snap ring 26 and are configured to be unrotatable.

The hydraulic servo 20 is positioned and fixed in the axial direction by a cylinder portion 21 that is spline-engaged with the spline portion 30s of the case 30, a piston member 22 that is disposed so as to be slidable in the axial direction with respect to the cylinder portion 21, a return spring not shown that urges the piston member 22 to the cylinder portion 21 side, and a snap ring 25. The hydraulic servo 20 has a retainer plate 24 for positioning the return spring. A gap between the cylinder portion 21 and the piston member 22 is sealed by seal rings 28, 29 so that a hydraulic oil chamber 23 is configured between a cylinder face 21a and a piston pressure receiving face 22a. Formed on the piston member 22 are, a pressing portion 22b in which the distal end is extended so as to face the friction portion 5 and that presses the friction portion 5, and a protrusion portion 22c that prevents the cylinder face 21a and the piston pressure receiving face 22a from sticking.

In the braking device 10 configured in this way, when hydraulic oil pressure is supplied from an oil passage of the case 30, which is not shown, to the hydraulic oil chamber 23, the piston member 22 is driven and pressed to the friction plate 5 side in the axial direction of an axial center of the friction plate 5, against an urging force of the return spring. The friction plates 1, the separator plates 2, and the end plates 3 are then engaged and the friction plates 1 are locked to the case 30 so that the braking device 10 is engaged (locked). Rotation of the rotary member 40 and members (not shown) such as gears that are drivingly coupled to the rotary member 40 is stopped so that the rotary member 40 and the members are unrotatable.

In contrast, when the hydraulic oil pressure is discharged from the hydraulic oil chamber 23, the urging force of the return spring causes the piston member 22 to move to the opposite side of the friction portion 5 in the axial direction. The friction plates 1, the separator plates 2, and the end plates 3 are then released so that braking device 10 is released. Rotation of the rotary member 40 and the members (not shown) such as gears that are drivingly coupled to the rotary member 40 is allowed so that the rotary member 40 and the members are rotatable. At this time, the lubrication oil goes over the friction material F that is fixed to the friction plates 1 so that the friction plate 1 and the separator plate 2 are spaced apart or the friction plate 1 and the end plate 3 are spaced apart. The friction material F is described in detail below.

A rotary shaft not shown is disposed in the center of the braking device 10. Lubrication oil is scattered from an oil passage formed in the rotary shaft toward the outer peripheral side and the lubrication oil is supplied from the friction portion 5, that is, the inner peripheral side of the friction plates 1. The lubrication oil that lubricates the motor-generator and the speed change mechanism not shown and the friction portion 5 described above drops to a lower part of the case 30 to form an oil sump, and a part of the friction portion 5 is immersed in the oil.

The friction material F is a general term for friction material segments F1 to F4 and ring-shaped friction materials FR1 to FR5 according to first to sixteenth embodiments described below, and indicate the entire friction material in the case where there are a plurality of divided friction material segments.

A friction plate 1₁ according to the first embodiment will be described with reference to FIG. 2. As illustrated in FIG. 2, the friction plate 1₁ has: a plate 1A in which the spline portion 1s is formed on the inner peripheral side, that has a hollow disk shape, and that is made of metal for example; and a friction material segment (first friction material segment) F1 and a friction material segment (second friction material segment) F2 that are fixed to a side face 1a of the plate 1A, that are a plurality of segments, and that are made of paper for example.

The friction material segment F1 and the friction material segment F2 are disposed to be uniformly aligned in the circumferential direction around a center (first center) CT that is an axis center of the plate 1A. Circumferential widths of the friction material segment F1 and the friction material segment F2 are formed to be the same width and widths in a direction orthogonal to the circumferential direction, that is, widths that are distances between an inner peripheral end portion and an outer peripheral end portion are different. That is, thirteen friction material segments F1 and three friction material segments F2 are disposed so as to be aligned in the circumferential direction, and the three friction material segments F2 are disposed at intervals of 90 degrees or more to be disposed as uniform as possible in the circumferential direction.

The friction material segment F1 is disposed at a position in which a position of an inner radial end portion is at a distance of a radius Din from the center CT1 and in which a position of an outer radial end portion is at a distance of a radius Dout1 from the center CT1. That is, a width in the direction orthogonal to the circumferential direction is formed to be a width (first width) W1, which is the difference between the radius Dout1 and the radius Din. An outer radial corner portion Rout1 and an inner radial corner portion Rin1 of the friction material segment F1 are formed to have a rounded shape with a prescribed curvature.

In contrast, the friction material segment F2 is disposed at a position in which the position of the inner radial end portion is at a distance of a radius Din2, which is larger than the radius Din1, from the center CT1, and in which the position of the outer radial end position is at a distance of a radius Dout2, which is smaller than the radius Dout1, from the center CT1. That is, a width in the direction orthogonal to the circumferential direction is formed to be a width (second width) W2, which is a difference between the radius Dout2 and the radius Dout1 and also smaller than the width WT. An outer radial corner portion and an inner radial corner portion of the friction material segment F1 are formed to have a rounded shape with a prescribed curvature. A position at a width center of the width W1 of the friction material segment F2 in the inner and outer radial direction is the same position (on the same radius) as a position at a width center of the width W2 of the friction material segment F1 in the inner and outer radial direction. That is, the widths orthogonal to the circumferential direction at the same position when viewed from the center CT1 are different.

A difference in the widths of the friction material segment F1 and the friction material segment F2 in the direction orthogonal to the circumferential direction (hereinafter referred to as a “width difference”) includes an outer radial width difference Wout1 and an inner radial width difference Win1 and forms a stepped shape with respect to the circumferential direction. In other words, the friction material segment F1 protrudes toward both the outer peripheral side and the inner peripheral side, relative to the friction material segment F2, and the overall friction material F is disposed so as to be nonuniform in the inner and outer peripheral direction with respect to the circumferential direction.

That is, in the friction material segment F2 (at least one friction material segment) of the friction material segments, the width W2 in the direction orthogonal to the circumferential direction is different from the width W1 of the friction material segment F1. Thus, the distance (radius Dout2) between the outer peripheral end portion and the center CT1 of the plate 1A is different from the distance (radius Dout1) between outer peripheral end portion of the friction material segment F1 (another friction material segment) and the center CT1 of the plate 1A. In addition, the distance (radius Din2) between the inner peripheral end portion and the center CT1 of the plate 1A is different from the distance (radius Din) between the inner peripheral end portion of the friction material segment F1 (another friction material segment) and the center CT1 of the plate 1A.

The friction plate 1₁ according to the first embodiment configured in this way rotates in conjunction with the rotation of the rotary member 40 when the braking device 10 is released. At this time, when the friction material segment F2 passes through and stirs the oil sump in the lower part of the case 30, the lubrication oil enters the outer radial width difference Wout1 described above, or the friction material segment F2 stirs the lubrication oil scattered from the inner peripheral side and the lubrication oil enters the inner radial width difference Win1, and the lubrication oil goes over the friction material segment F1 with the rotation of the friction plate 1₁. Besides the lubrication oil that enters the interval between the friction material segment F1 and the friction material segment F2, the lubrication oil in the outer radial width difference Wout1 and the inner radial width difference Win1 also goes over the friction material segment F1. Accordingly, the amount of lubrication oil that is fed to the surface of the friction material segment F1 is increased, the separation force between the friction plate 1₁ and the separator plate 2 and between the friction plate 1₁ and the end plate 3 in the axial direction is increased so that the intervals therebetween can be expanded. With an increase in the amount of lubrication oil that is fed to the surface of the friction material segment F2, it is thus possible to attempt reduction of the drag torque.

### Second Embodiment

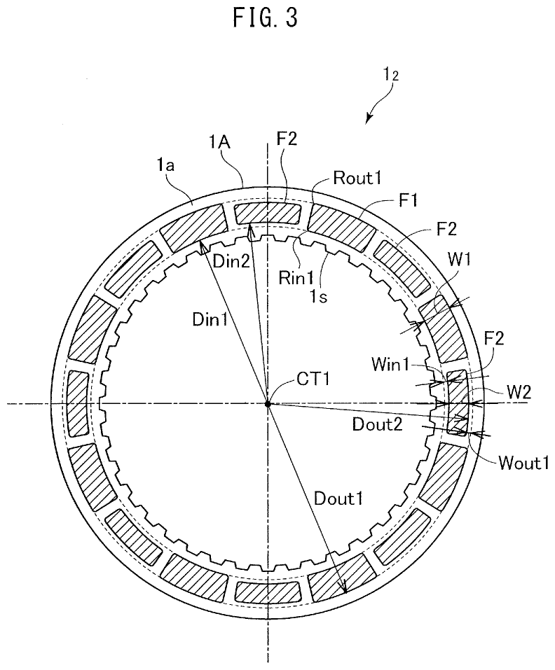

A second embodiment, which is a partial modification of the first embodiment, will be described with reference to FIG. 3. FIG. 3 is a front view of a friction plate according to the second embodiment. In the second embodiment, components that are similar to those in the first embodiment described above are given the same symbols to omit description.

As illustrated in FIG. 3, the number and arrangement of the friction material segments F2 are changed in a friction plate 1₂ according to the second embodiment, compared to the first embodiment described above. In detail, the friction material segment (first friction material segment) F1 and the friction material segment (second friction material segment) F2 are disposed alternately in the circumferential direction. In other words, the friction material segment F1 protrudes toward both the outer peripheral side and the inner peripheral side, relative to the friction material segment F2, and the overall friction material F is disposed so as to be nonuniform in the inner and outer peripheral direction with respect to the circumferential direction.

As in the first embodiment, in the friction material segment F2 of the friction material segments (at least one friction material segment), the width W2 in the direction orthogonal to the circumferential direction is different from the width W1 of the friction material segment F. Thus, the distance (radius Dout2) between the outer peripheral end portion and the center CT1 of the plate 1A is different from the distance (radius Dout1) between outer peripheral end portion of the friction material segment F1 (another friction material segment) and the center CT1 of the plate A. In addition, the distance (radius Din2) between the inner peripheral end portion and the center CT1 of the plate 1A is different from the distance (radius Din1) between the inner peripheral end portion of the friction material segment F1 (another friction material segment) and the center CT1 of the plate 1A.

In the friction plate 1₂ according to the second embodiment configured in this way, the total area of the outer radial width difference Wout1 and the inner radial width difference Win1 is increased, compared to the first embodiment. Accordingly, the amount of lubrication oil that is fed to the surface of the friction material segment F1 is increased, and the separation force between the friction plate 1₂ and the separator plate 2 and between the friction plate 1₂ and the end plate 3 in the axial direction is increased. Since the friction material segment F1 and the friction material segment F2 are disposed alternately in the circumferential direction, the surface area of the friction material F is made uniform in the inner and outer radial direction and in the circumferential direction. When the braking device 10 is engaged, engagement torque is made uniform and it is possible to attempt prevention of the torque variation.

Since other functions and effects are similar to those of the first embodiment, description thereof will be omitted.

### Third Embodiment

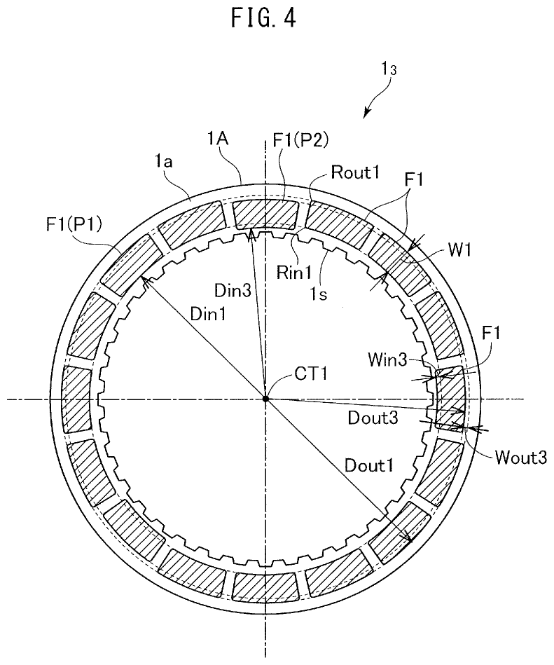

A third embodiment, which is a partial modification of the first embodiment, will be described with reference to FIG. 4. FIG. 4 is a front view of a friction plate according to the third embodiment. In the third embodiment, components that are similar to those in the first embodiment described above are given the same symbols to omit description.

As illustrated in FIG. 4, in a friction plate 1₃ according to the third embodiment, all the friction materials F are configured of the same friction material segments F1. The friction plate 1₃ has a different arrangement position in the inner and outer peripheral direction, compared to the first embodiment described above.

In detail, in the friction plate 1₃, the friction material segment F1 at a first position P1 and the friction material segment F1 at a second position P2 are disposed side by side in the circumferential direction. Here, the friction material segment F1 at the first position P1 is disposed at a position at which the position of the inner radial end portion is at a distance of the radius (second distance) Din1 from the center CT1 and the position of the outer radial end portion is at a distance of the radius Dout1 from the center CT1. The friction material segment F1 at the second position P2 is disposed at a position at which the position of the inner radial end portion is at a distance of the radius (first distance) Din3, which is smaller than the radius Din1, from the center CT1, and the position of the outer radial end portion is at a distance of the radius Dout3, which is smaller than the radius Dout1, from the center CT1. That is, the friction material segment F1 at the second position P2 is disposed to the inner peripheral side with respect to the friction material segment F1 at the first position P. In other words, the friction material segment F1 at the first position P1 is disposed on the outer peripheral side with respect to the friction material segment F1 at the second position P2. This means that the friction material segment F1 at the second position P2 protrudes to the inner peripheral side with respect to the friction material segment F1 at the first position P1, and the friction material segment F1 at the first position P1 protrudes to the outer peripheral side with respect to the friction material segment F1 at the second position P2. The overall friction material F is disposed so as to be nonuniform in the inner and outer peripheral direction with respect to the circumferential direction.

The radial disposition of the friction material segment F1 at the second position P2 (at least one friction material segment) among the friction material segments differs from that of the friction material segment F1 at the first position P. Thus, the distance (radius Dout3) between the outer peripheral end portion and the center CT1 of the plate 1A differs from the distance (radius Dout1) between the outer peripheral end portion of the friction material segment F1 at the first position P1 (another frictional material segment) and the center CT1 of the plate 1A. In addition, the distance (radius Din3) between the inner peripheral end portion and the center CT1 of the plate A differs from the distance (radius Din1) between the inner peripheral end portion of the friction material segment F1 at the first position P1 (another friction material segment) and the center CT1 of the plate 1A.

In the friction plate 1₃ according to the third embodiment configured in this way, there is a width difference Wout3 on the outer peripheral side of the friction material segment F1 at the second position P2 and there is a width difference Win3 on the inner peripheral side of the friction material segment F1 at the first position P. Accordingly, the amount of lubrication oil that is fed to the surface of the friction material segment F1 is increased, and the separation force between the friction plate 1₃ and the separator plate 2 and between the friction plate 1₃ and the end plate 3 in the axial direction is increased.

Since other functions and effects are similar to those of the first embodiment, description thereof will be omitted.

### Fourth Embodiment

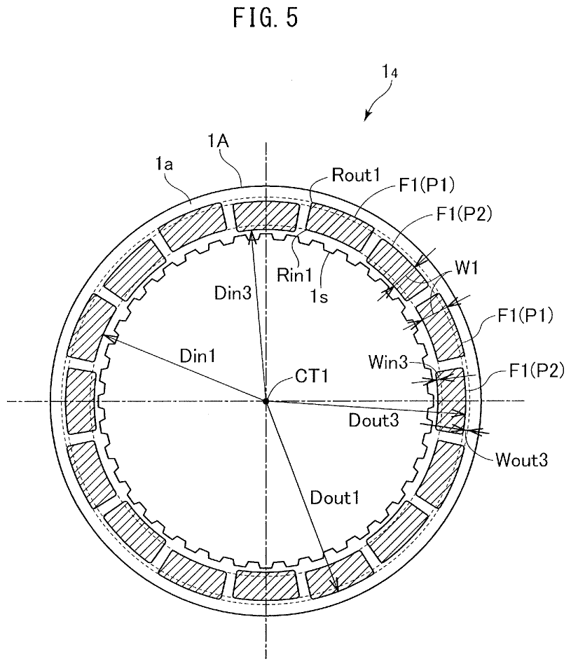

A fourth embodiment, which is a partial modification of the third embodiment, will be described with reference to FIG. 5. FIG. 5 is a front view of a friction plate according to the fourth embodiment. In the fourth embodiment, components that are similar to those in the third embodiment described above are given the same symbols to omit description.

As illustrated in FIG. 5, the number and arrangement of the friction material segments F1 at the second position P2 are changed in a friction plate 1₄ according to the fourth embodiment, compared to the third embodiment described above. In detail, the friction material segment F1 at the first position P1 and the friction material segment F1 at the second position P2 are disposed alternately in the circumferential direction. This means that the friction material segment F1 at the second position P2 protrudes to the inner peripheral side with respect to the friction material segment F1 at the first position P1, and the friction material segment F1 at the first position P1 protrudes to the outer peripheral side with respect to the friction material segment F1 at the second position P2. The overall friction material F is disposed so as to be nonuniform in the inner and outer peripheral direction with respect to the circumferential direction.

Similar to the third embodiment, the radial disposition of the friction material segment F1 at the second position P2 (at least one friction material segment) among the friction material segments differs from that of the friction material segment F1 at the first position P. Thus, the distance (radius Dout3) between the outer peripheral end portion and the center CT1 of the plate 1A differs from the distance (radius Dout1) between the outer peripheral end portion of the friction material segment F1 at the first position P1 (another frictional material segment) and the center CT1 of the plate A. In addition, the distance (radius Din3) between the inner peripheral end portion and the center CT1 of the plate 1A differs from the distance (radius Din) between the inner peripheral end portion of the friction material segment F1 at the first position P1 (another friction material segment) and the center CT1 of the plate 1A.

In the friction plate 1₄ according to the fourth embodiment configured in this way, the total area of the outer radial width difference Wout3 and the inner radial width difference Win3 is increased, compared to the third embodiment. Accordingly, the amount of lubrication oil that is fed to the surface of the friction material segment F1 is increased, and the separation force between the friction plate 1₄ and the separator plate 2 and between the friction plate 1₄ and the end plate 3 in the axial direction is increased. Since the friction material segment F1 at the first position P1 and the friction material segment F1 at the second position P2 are disposed alternately in the circumferential direction, the friction material F is made uniform in the inner and outer radial direction and in the circumferential direction. When the braking device 10 is engaged, engagement torque is made uniform and it is possible to attempt prevention of the torque variation.

Since other functions and effects are similar to those of the third embodiment, description thereof will be omitted.

### Fifth Embodiment

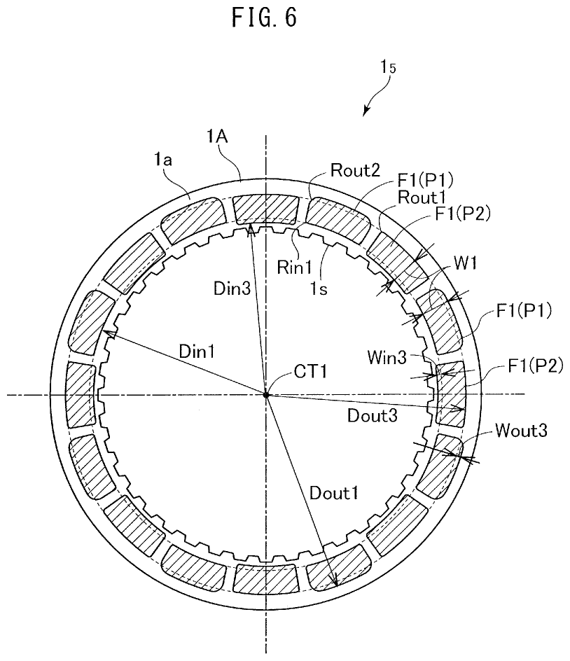

A fifth embodiment, which is a partial modification of the fourth embodiment, will be described with reference to FIG. 6. FIG. 6 is a front view of a friction plate according to the fifth embodiment. In the fifth embodiment, components that are similar to those in the fourth embodiment described above are given the same symbols to omit description.

As illustrated in FIG. 6, in a friction plate 1₅ according to the fifth embodiment, an outer radial corner portion Rout2 of the friction material segment F1 at the first position P1 is formed to have a rounded shape in which the curvature thereof is larger than a curvature of an outer radial corner portion Rout1 of the friction material segment F1 at the second position P2, compared to the fourth embodiment described above.

Similar to the fourth embodiment, the radial disposition of the friction material segment F1 at the second position P2 (at least one friction material segment) among the friction material segments differs from that of the friction material segment F1 at the first position P. Thus, the distance (radius Dout3) between the outer peripheral end portion and the center CT1 of the plate 1A differs from the distance (Dout1) between the outer peripheral end portion of the friction material segment F1 at the first position P1 (another frictional material segment) and the center CT1 of the plate 1A. In addition, the distance (radius Din3) between the inner peripheral end portion and the center CT1 of the plate 1A differs from the distance (radius Din) between the inner peripheral end portion of the friction material segment F1 at the first position P1 (another friction material segment) and the center CT1 of the plate 1A.

In the friction plate 1₅ according to the fifth embodiment configured in this way, compared to the fourth embodiment described above, the lubrication oil that collides when going over the friction material segment F1 at the first position P1 now goes over smoothly with the outer radial width difference Wout3, the durability of the friction material segment F1 at the first position P1 can be improved, the shearing resistance of the lubrication oil is decreased, and the drag torque can be attempted to be decreased.

Since other functions and effects are similar to those of the fourth embodiment, description thereof will be omitted.

### Sixth Embodiment

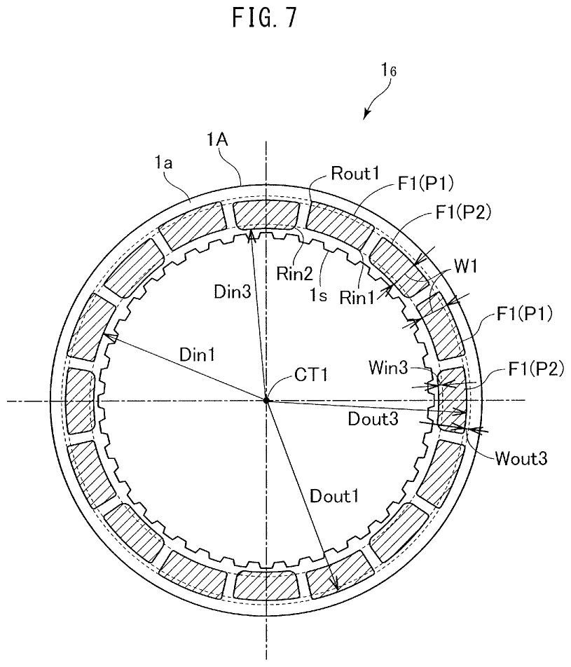

A sixth embodiment, which is a partial modification of the fourth embodiment described above, will be described with reference to FIG. 7. FIG. 7 is a front view of a friction plate according to a sixth embodiment. In the sixth embodiment, components that are similar to those in the fourth embodiment described above are given the same symbols to omit description.

As illustrated in FIG. 7, in a friction plate 1₆ according to the sixth embodiment, an inner radial corner portion Rin2 of the friction material segment F1 at the second position P2 is formed to have a rounded shape in which the curvature thereof is larger than a curvature of an inner radial corner portion Rin1 of the friction material segment F1 at the first position P1, compared to the fourth embodiment described above.

Similar to the fourth embodiment, the radial disposition of the friction material segment F1 at the second position P2 (at least one friction material segment) among the friction material segments differs from that of the friction material segment F1 at the first position P. Thus, the distance (radius Dout3) between the outer peripheral end portion and the center CT1 of the plate 1A differs from the distance (Dout1) between the outer peripheral end portion of the friction material segment F1 at the first position P1 (another frictional material segment) and the center CT1 of the plate 1A. In addition, the distance (radius Din3) between the inner peripheral end portion and the center CT1 of the plate 1A differs from the distance (radius Din) between the inner peripheral end portion of the friction material segment F1 at the first position P1 (another friction material segment) and the center CT1 of the plate 1A.

In the friction plate 1₆ according to the sixth embodiment configured in this way, compared to the fourth embodiment, the lubrication oil that collides when going over the friction material segment F1 at the second position P2 now goes over smoothly with the inner radial width difference Win3, the durability of the friction material segment F1 at the second position P2 can be improved, the shearing resistance of the lubrication oil can be decreased, and the drag torque can be attempted to be decreased. In the sixth embodiment, the curvature of the outer radial corner portion Rout1 of the friction material segment F1 at the first position P1 is smaller than the curvature of the corner portion Rout2 according to the fifth embodiment. However, similar to the curvature of the corner portion Rout2 according to the fifth embodiment, the curvature of the outer radial corner portion of the friction material segment F1 at the first position P1 may be set to be large.

Since other functions and effects are similar to those of the fourth embodiment, description thereof will be omitted.

### Seventh Embodiment

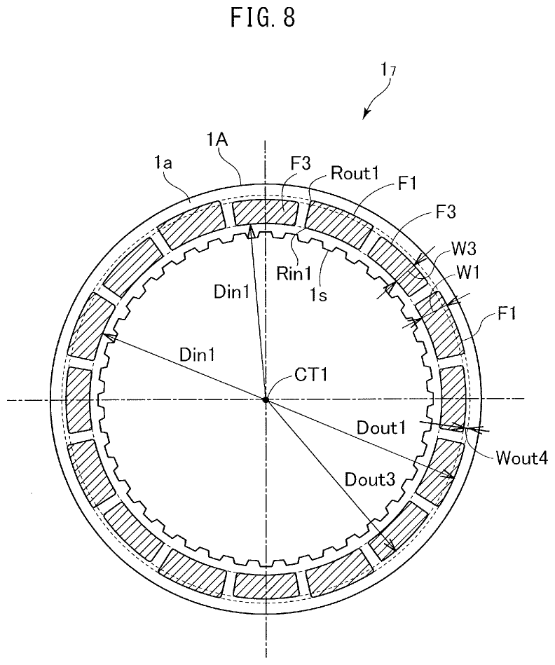

A seventh embodiment, which is a partial modification of the second embodiment, will be described with reference to FIG. 8. FIG. 8 is a front view of a friction plate according to the seventh embodiment. In the seventh embodiment, components that are similar to those in the second embodiment described above are given the same symbols to omit description.

As illustrated in FIG. 8, in a friction plate 1₇ according to the seventh embodiment, the friction material F is configured so that the friction material segment (first friction material segment) F1 and the friction material segment (second friction material segment) F3 are disposed alternately in the circumferential direction, compared to the second embodiment described above. Here, the width of the friction material segment F1 in the direction orthogonal to the circumferential direction is the width (first width) W1 and the width (second width) W3 of the friction material segment F3 is smaller than the width W1. In other words, a friction material segment F3 having the width W3 that is larger than the width W2 of the friction material segment F2 is disposed instead of the friction material segment F2.

In detail, in the friction plate 1₇, the friction material segment F1 and the friction material segment F3 are disposed side by side in the circumferential direction. Here, the friction material segment F1 is disposed so that the position of the inner radial end portion is at the position at the radius Dout1 from the center CT1 and so that the position of the outer radial end portion is at the position the distance to which from the center CT1 is the radius Dout1. The friction material segment F3 is disposed so that the position of the inner radial end portion is at the position at the radius Din from the center CT1 and the position of the outer radial end portion is at the position of the radius Dout3, which is shorter than the radius Dout1, from the center CT1. That is, the friction material segment F3 is disposed so that the position of the outer radial end portion is positioned on the inner peripheral side with respect to the friction material segment F1 by an amount of the width difference Wout4 between the width W1 and the width W3, and so that the positions of the inner radial end portions of the friction material segment F1 and the friction material segment F3 are disposed at the same position in the circumferential direction. This means that the outer peripheral end portion of the friction material segment F3 is retracted to the inner peripheral side with respect to the outer radial end portion of the friction material segment F1 and the overall friction material F is disposed so that only the outer peripheral side is nonuniform in the inner and outer peripheral direction with respect to the circumferential direction.

That is, the width W3 of the friction material segment F3 (at least one friction material segment) of the friction material segments in the direction orthogonal to the circumferential direction is different from the width W1 of the friction material segment F1. Thus, the distance (radius Dout3) between the outer peripheral end portion and the center CT1 of the plate 1A is different from the distance (radius Dout1) between the outer peripheral end portion of the friction material segment F1 (another friction material segment) and the center CT1 of the plate 1A.

In the friction plate 1₇ according to the seventh embodiment configured in this way, there is an outer radial width difference Wout4 on the outer peripheral side of the friction material segment F3. Accordingly, the amount of lubrication oil that is fed to the surface of the friction material segment F1 is increased, and the separation force between the friction plate 1₇ and the separator plate 2 and between the friction plate 1₇ and the end plate 3 in the axial direction is increased. The friction plate 1₇ according to the seventh embodiment is effective when a lower part of the friction material segment F1 or the friction material segment F3 which is positioned at the bottom is immersed and the friction material segment F1 or the friction material segment F3 which is positioned at the bottom is not entirely immersed in the oil sump at the lower part of the case 30.

Since other functions and effects are similar to those of the second embodiment, description thereof will be omitted.

### Eighth Embodiment

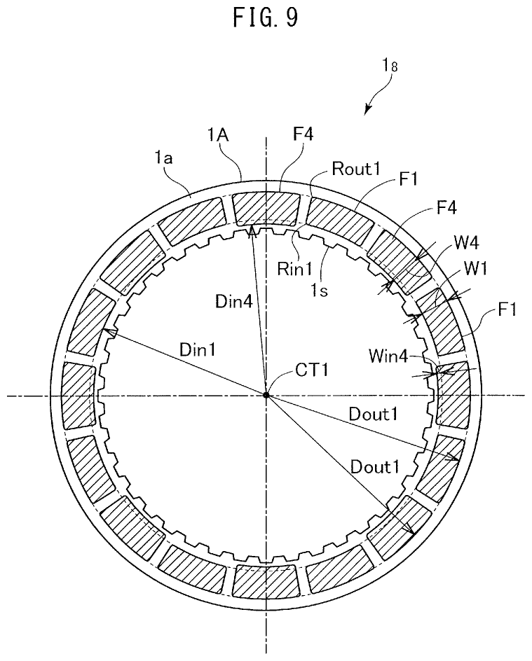

An eighth embodiment, which is a partial modification of the second embodiment, will be described with reference to FIG. 9. FIG. 9 is a front view of a friction plate according to the eighth embodiment. In the eighth embodiment, components that are similar to those in the second embodiment described above are given the same symbols to omit description.

As illustrated in FIG. 9, in a friction plate 1₈ according to the eighth embodiment, the friction material F is configured so that the friction material segment (first friction material segment) F1 and the friction material segment (first friction material segment) F4 are disposed alternately in the circumferential direction, compared to the second embodiment described above. Here, the width of the friction material segment F1 in the direction orthogonal to the circumferential direction is the width (second width) W1 and the width (first width) W4 of the friction material segment F4 is larger than the width W1. In other words, the friction material segment F4 having the width W4 that is larger than the width W2 of the friction material segment F2 is disposed instead of the friction material segment F2.

In detail, in the friction plate 1₈, the friction material segment F1 and the friction material segment F4 are disposed side by side in the circumferential direction. Here, the friction material segment F1 is disposed so that the position of the inner radial end portion is at the position at the radius Din1 from the center CT1 and so that the position of the outer radial end portion is at the position the distance to which from the center CT1 is the radius Dout1. The friction material segment F4 is disposed so that the position of the inner radial end portion is at the position at the distance of the radius Din4, which is shorter than the radius Din1, from the center CT1 and the position of the outer radial end portion is at the position at the distance Dout1 from the center CT1. That is, the friction material segment F4 is disposed so that the position of the inner radial end portion is positioned on the inner peripheral side with respect to the friction material segment F4 by an amount of the width difference Win4 between the width W1 and the width W4, and so that the positions of the outer radial end portions of the friction material segment F1 and the friction material segment F4 are disposed at the same position in the circumferential direction. This means that the inner peripheral end portion of the friction material segment F1 is retracted to the outer peripheral side with respect to the inner peripheral end portion of the friction material segment F4 and the overall friction material F is disposed so that only the inner peripheral side is nonuniform in the inner and outer peripheral direction with respect to the circumferential direction.

That is, the width W4 of the friction material segment F4 (at least one friction material segment) of the friction material segments in the direction orthogonal to the circumferential direction is different from the width W1 of the friction material segment F1. Thus, the distance (radius Din4) between the inner radial end portion and the center CT1 of the plate 1A is different from the distance (radius Din1) between the inner radial end portion of the friction material segment F1 (another friction material segment) and the center CT1 of the plate 1A.

In the friction plate 1₈ according to the eighth embodiment configured in this way, there is an inner radial width difference Win4 on the outer peripheral side of the friction material segment F1. Accordingly, the amount of lubrication oil that is fed to the surface of the friction material segment F4 is increased, and the separation force between the friction plate 1₈ and the separator plate 2 and between the friction plate 1₈ and the end plate 3 in the axial direction is increased. It can be said that such a friction plate 1₈ according to the eighth embodiment is effective when the amount of lubrication oil scattered from the inner radial side is more than that of the second embodiment.

Since other functions and effects are similar to those of the second embodiment, description thereof will be omitted.

### Ninth Embodiment

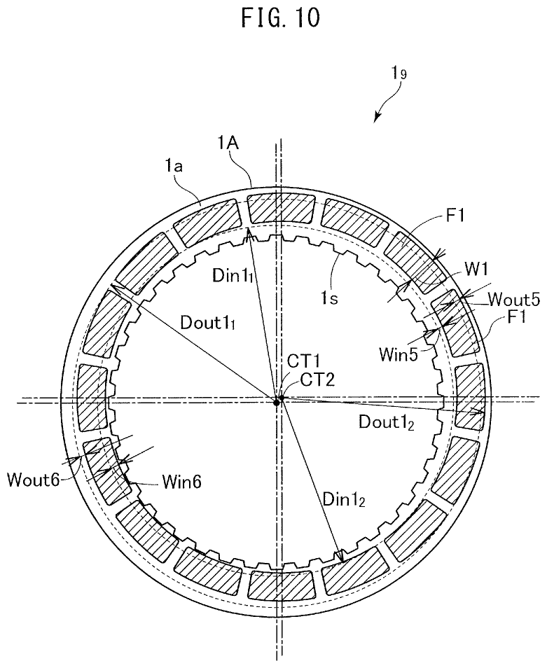

A ninth embodiment, which is a partial modification of the first embodiment, will be described with reference to FIG. 10. FIG. 10 is a front view of a friction plate according to the ninth embodiment. In the ninth embodiment, components that are similar to those in the first embodiment described above are given the same symbols to omit description.

As illustrated in FIG. 10, in a friction plate 1₉ according to the ninth embodiment, the friction materials F are all configured of the same friction material segment F1 and the center position of all friction material segments F1 are disposed at a center (second center) CT2 shifted with respect to the center CT1, compared to the first embodiment described above.

In detail, in the friction plate 1₉, all friction material segments F1 are disposed so that the position of the inner radial end portion is at the position the distance to which from CT2 that is shifted with respect to the center CT1 so as to be offset is the radius Din1₂ that is the same length as the radius Din1₁ and so that the position of the outer radial end portion is at the position the distance to which from the center CT2 is the radius Dout1₂ that is the same length as the radius Dout1₁. That is, the friction material segment F1 is disposed on the circumference that is offset with respect to an outer circle with a radius Dout1₁ from the center CT1 and an inner circle with a radius Din1₁ from the center CT1. In this way, in the offset direction where the center CT2 is offset from the center CT1, a width difference Wout5 from the outer peripheral circle of the center CT1 and a width difference Win5 from the inner peripheral circle of the center CT1 arise, on the side having the center CT2 with respect to the center CT1. In contrast, a width difference Wout6 from the outer peripheral circle of the center CT1 and a width difference Win6 from the inner peripheral circle of the center CT1 arise, on the side having the center CT1 with respect to the center CT2. The overall friction material F is disposed so as to be nonuniform in the inner and outer peripheral direction with respect to the circumferential direction.

That is, one of the friction material segments, for example the friction material segment F1 (at least one friction material segment) on the side having the center CT2 with respect to the CT1 and in contrast the friction material segment F1 (at least one friction material segment) on the side having the center CT1 with respect to the center CT2 have different distances from the center CT1 of the plate 1A since they are disposed about the center CT2 different from the center CT1. Thus, the distance between the outer peripheral end portion and the center CT1 of the plate 1A is different from the distance between the outer peripheral end portion of other friction material segments F1 (other friction material segments) and the center CT1 of the plate 1A. In addition, the distance between the inner peripheral end portion and the center CT1 of the plate 1A is different from the distance between the inner peripheral end portion of other friction material segments F1 (other friction material segments) and the center CT1 of the plate 1A.

In the friction plate 1₉ according to the ninth embodiment configured in this way, there is an increase in the amount of lubrication oil that is fed to the surface of the friction material segment F1 at a part in which there is the width difference Win5 on the inner peripheral side of the friction material segment F1. In addition, there is an increase in the amount of lubrication oil that is fed to the surface of the friction material segment F1 at a part in which there is the width difference Wout6 on the outer peripheral side of the friction material segment F1. Further, there is an increase in the separation force between the friction plate 1₉ and the separator plate 2 and between the friction plate 1₉ and the end plate 3 in the axial direction.

Since other functions and effects are similar to those of the first embodiment, description thereof will be omitted.

### Tenth Embodiment

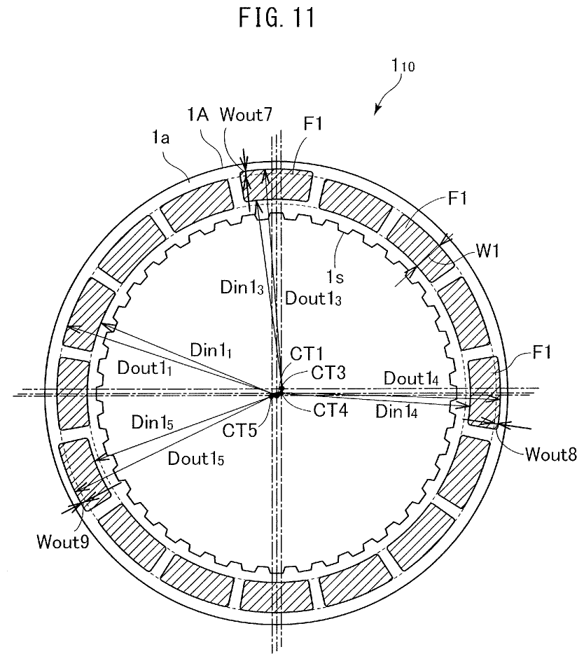

A tenth embodiment, which is a partial modification of the first embodiment, will be described with reference to FIG. 11. FIG. 11 is a front view of a friction plate according to the tenth embodiment. In the tenth embodiment, components that are similar to those in the first embodiment described above are given the same symbols to omit description.

As illustrated in FIG. 11, in a friction plate 1₁₀ according to the tenth embodiment, the friction materials F are all configured of the same friction material segment F1 and the center position of three friction material segments F1 are disposed at a center (second center) CT3, a center (second center) CT4, and a center (second center) CT5 that are shifted with respect to the center CT1, compared to the first embodiment described above. The center CT3, the center CT4, and the center CT5 are disposed so that the offset amount at which each center is offset with respect to the center CT1 is different.

In detail, disposed in the friction plate 1₁₀ are: thirteen friction material segments F1 in which the position of the inner radial end portion is at the position the distance to which from the center CT1 is the radius Din1₁ and the position of the outer radial end portion is at the position the distance to which from the center CT1 is the radius Dout1₁; the friction material segment F1 in which the position of the inner radial end portion is at the position the distance to which from CT3 that is shifted with respect to the center CT1 so as to be offset is a radius Din1₃ that is the same length as the radius Din1₁, and so that the position of the outer radial end portion is at the position the distance to which from the center CT3 is a radius Dout1₃ which is the same length as the radius Dout1₁; the friction material segment F1 in which the position of the inner radial end portion is at the position the distance to which from CT4 that is shifted with respect to the center CT1 so as to be offset is a radius Din1₄ that is the same length as the radius Din1, and so that the position of the outer radial end portion is at the position the distance to which from the center CT4 is the radius Dout1₄ that is the same length as the radius Dout1₁; and the friction material segment F1 in which the position of the inner radial end portion is at the position the distance to which from CT5 that is shifted with respect to the center CT1 so as to be offset is a radius Din1₅ that is the same length as the radius Din1₁, and so that the position of the outer radial end portion is at the position the distance to which from the center CT5 is a radius Dout1₅ that is the same length as the radius Dout1₁.

That is, the three friction material segments F1 are disposed on the circumference that is offset with respect to the outer circle with the radius Dout1₁ from the center CT1 and the inner circle with the radius Din1 from the center CT1. Thus, there is a width difference Wout7 between the friction material segment F1 having the center CT3 and the outer peripheral circle having the center CT1, there is a width difference Wout8 between the friction material segment F1 having the center CT4 and the outer peripheral circle having the center CT1 and there is a width difference Wout9 between the friction material segment F1 having the center CT5 and the outer peripheral circle having the center CT1. The overall friction material F is disposed so as to be nonuniform in the inner and outer peripheral direction with respect to the circumferential direction.

The friction material segment F1 (at least one friction material segment) among the friction material segments that is disposed so that the center is offset from the center CT1 is disposed around the centers CT3, CT4, CT5 that are different from the center CT1, and thus the distance from the center CT1 is different. Thus, the distance between the outer peripheral end portion of the at least one friction material segment and the center CT1 of the plate 1A is different from the distance between the outer peripheral end portion of the friction material segment F1 (another friction material segment) that is disposed around the center CT1 and the center CT1 of the plate 1A. In addition, the distance between the inner peripheral end portion of the at least one friction material segment and the center CT1 of the plate 1A is different from the distance between the inner peripheral end portion of the friction material segment F1 (another friction material segment) that is disposed around the center CT1 and the center CT1 of the plate A.

In the friction plate 1₁₀ according to the tenth embodiment configured in this way, there is an increase in the amount of lubrication oil that is fed to the surface of the friction material segments F1 at the parts in which there are the width difference Wout7, the width difference Wout8, and the width difference Wout9 on the outer peripheral side of the friction material segment F1. In addition, there is an increase in the separation force between the friction plate 1₁₀ and the separator plate 2 and between the friction plate 1₁₀ and the end plate 3 in the axial direction. In the tenth embodiment, the center CT3, the center CT4, and the center CT5 are disposed so as to have a different offset amount by which each center is offset with respect to the center CT1. In addition, the radius Din1₃, the radius Din1₄, and the radius Din1₅ (or the radius Dout1₃, the radius Dout1₄, and the radius Dout1₅) described above are the same length. However, the offset amount may be the same and the radius Din1₃, the radius Din1₄, and the radius Din1₅ (the radius Dout1₃, the radius Dout1₄, and the radius Dout1₅) may be different lengths.

Since other functions and effects are similar to those of the first embodiment, description thereof will be omitted.

### Eleventh Embodiment

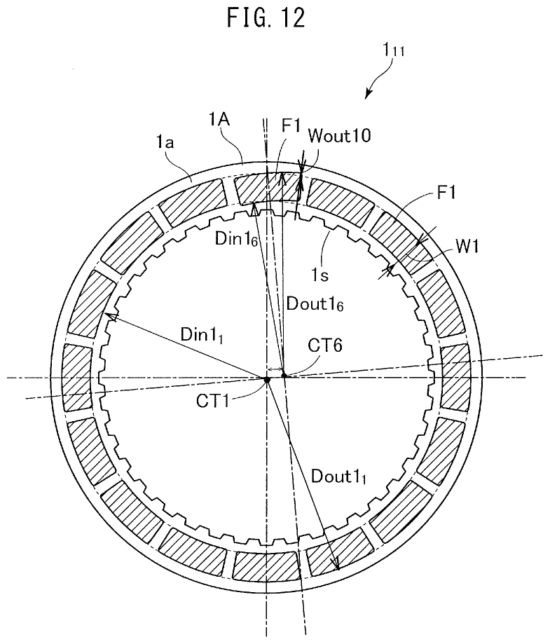

An eleventh embodiment, which is a partial modification of the first embodiment, will be described with reference to FIG. 12. FIG. 12 is a front view of a friction plate according to the eleventh embodiment. In the eleventh embodiment, components that are similar to those in the first embodiment described above are given the same symbols to omit description.

As illustrated in FIG. 12, in a friction plate 1₁₁ according to the eleventh embodiment, the friction materials F are all configured of the same friction material segments F1, compared to the first embodiment described above. The center position of one friction material segment F1 among the friction material segments F1 is disposed so that a center (third center) CT6 is shifted with respect to the center CT1 and so that the radiating direction is inclined with respect to the radiating direction of the center CT1.

In detail, disposed in the friction plate 1₁₁ are: fifteen friction material segments F1 in which the position of the inner radial end portion is at the position the distance to which from the center CT1 is the radius Din1₁ and the position of the outer radial end portion is at the position the distance to which from the CT1 is the radius Dout1₁; and the friction material segment F1 in which the position of the inner radial end portion is at the position the distance to which from the CT6 that is shifted from the center CT1 so as to be offset is a radius Din1₆ that is the same length as the radius Din1₁, inclined in the radiating direction, and the position of the outer radial end portion is at the position the distance to which from the center CT6 is the radius Dout1₆ that is the same length as the radius Dout1₁, inclined in the radiating direction, and which is inclined with respect to the circumferential direction (or with respect to a direction orthogonal to the circumferential direction).

That is, the inclined friction material segment F1 having the center CT6 is disposed on the circumference that is offset with respect to the outer circle having the radius Dout1₁ from the center CT1 and the inner circle having the radius Din1₁ from the center CT1, and is disposed so as to be inclined with respect to the circumferential direction. In this way, there is a width difference Wout10 between the friction material segment F1 having the center CT6 and the outer peripheral circle having the center CT1, and the overall friction material F is disposed so as to be nonuniform in the inner and outer peripheral direction with respect to the circumferential direction.

The friction material segment F1 (at least one friction material segment) among the friction material segments that is disposed so as to be inclined with respect to the circumferential direction includes: a part in which a distance from the center is different only for the amount inclined in the circumferential direction; a part in which the distance between the outer peripheral end portion and the center CT1 of the plate 1A is different from the distance between the outer peripheral end portion of the friction material segment F1 (another friction material segment) that is not inclined with respect to the circumferential direction and the center CT1 of the plate 1A; and a part in which the distance between the inner peripheral end portion and the center CT1 of the plate 1A is different from the inner peripheral end portion of the friction material segment F1 (another friction material segment) that is not inclined with respect to the circumferential direction and the center CT1 of the plate 1A.

In the friction plate 1₁ according to the eleventh embodiment configured in this way, there is an increase in the amount of lubrication oil that is fed to the surface of the friction material segment F1 at the parts in which there is the width difference Wout10 on the outer peripheral side of the friction material segment F. In addition, there is an increase in the separation force between the friction plate 1₁₁ and the separator plate 2 and between the friction plate 1₁₁ and the end plate 3 in the axial direction. In the eleventh embodiment, the configuration in which the center is offset for only one friction material segment F1 so that the friction material segment F1 is inclined is described. However, the center for a plurality of the friction material segments may be offset so that the friction material segments are inclined. In such a case, the center of each inclined friction material segment may be the same or may be different.

Since other functions and effects are similar to those of the first embodiment, description thereof will be omitted.

### Twelfth Embodiment

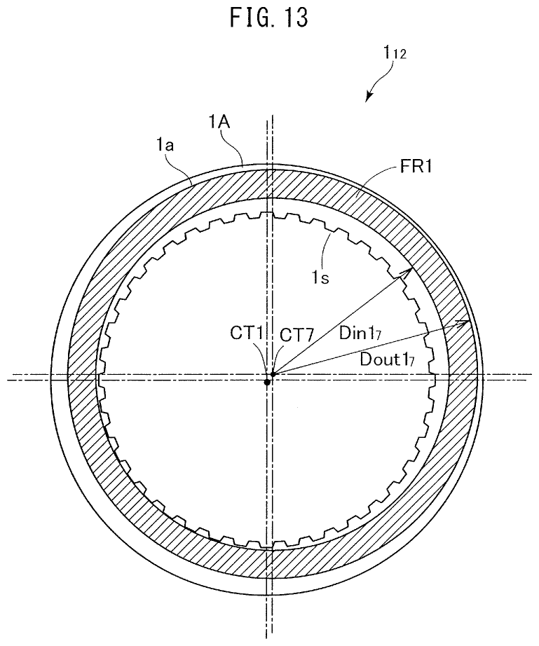

A twelfth embodiment, which is a partial modification of the first embodiment, will be described with reference to FIG. 13. FIG. 13 is a front view of a friction plate according to the twelfth embodiment. In the twelfth embodiment, components that are similar to those in the first embodiment described above are given the same symbols to omit description.

As illustrated in FIG. 13, in a friction plate 1₁₂ according to the twelfth embodiment, the friction material F is configured of a ring-shaped friction material FR1 in which the width orthogonal to the circumferential direction is the same width, and the center position of the ring-shaped friction material FR1 is disposed at a center (fourth center) CT7 that is shifted with respect to the center CT1, compared to the first embodiment described above. It is possible to improve durability of the friction material by configuring the friction material F in a ring shape.

In detail, in the friction plate 1₁₂, the friction material FR1 is disposed so that the position of the inner radial end portion is at the position the distance to which from CT7 that is shifted with respect to the center CT1 so as to be offset is a radius Din1₇ that is the same length as the radius Din1₁, and so that the position of the outer radial end portion is at the position the distance from the center CT7 is a radius Dout1₇ that is the same length as the radius Dout1₁. In this way, the inner peripheral end portion and the outer peripheral end portion are offset in the inner and outer peripheral direction for the amount that the center CT7 is offset from the center CT1, and the overall friction material FR1 is disposed so as to be nonuniform in the inner and outer peripheral direction with respect to the circumferential direction.

That is, in the friction material FR1 that is disposed so that the center is offset from the center CT1, the distance from the center CT1 is different since the friction material FR1 is disposed around the center CT7, which is different from the center CT1. The distance between the outer peripheral end portion of at least one spot in the circumferential direction and the center CT1 of the plate 1A is different from the distance between the outer peripheral end portion at other spots in the circumferential direction and the center CT1 of the plate 1A. The distance between the inner peripheral end portion of at least one spot in the circumferential direction and the center CT1 of the plate 1A is different from the distance between the inner peripheral end portion at other spots in the circumferential direction and the center CT1 of the plate A.

In the friction plate 1₁₂ according to the twelfth embodiment configured in this way, there is an increase in the amount of lubrication oil that is fed to the surface of the friction material FR1 at the part that is offset to the inner peripheral side and the outer peripheral side of the friction material FR1. There is also an increase in the separation force in the axial direction between the friction plate 1₁₂ and the separator plate 2 and between the friction plate 1₁₂ and the end plate 3.

Since other functions and effects are similar to those of the first embodiment, description thereof will be omitted.

### Thirteenth Embodiment

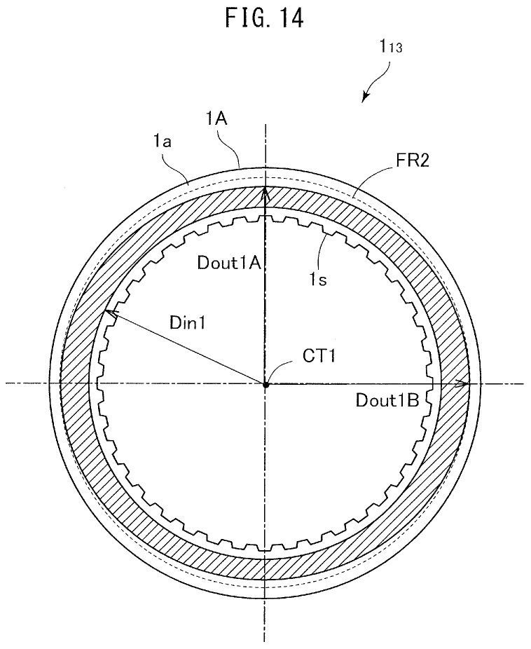

A thirteenth embodiment, which is a partial modification of the first embodiment, will be described with reference to FIG. 14. FIG. 14 is a front view of a friction plate according to the thirteenth embodiment. In the thirteenth embodiment, components that are similar to those in the first embodiment described above are given the same symbols to omit description.

As illustrated in FIG. 14, in a friction plate 1₁₃ according to the thirteenth embodiment, the friction material F is configured of a ring-shaped friction material FR2 in which the inner peripheral end portion is formed with a circle having the center CT1 and the outer peripheral end portion is formed with an ellipse having the center CT, compared to the first embodiment described above. It is possible to improve durability of the friction material by configuring the friction material F in a ring shape.

In detail, the ring-shaped friction material FR2 is disposed in the friction plate 1₁₃ so that the position of the inner radial end portion is at the position at a distance of the radius Din1 from the center CT1, and the position of the outer radial end portion is at the position of the ellipse in which the short side is a radius Dout1A and the long side is a radius Dout1B as the distances from the center CT1. Since the outer peripheral end portion has an elliptic shape and the lengths in the inner and outer peripheral direction are different, the overall friction material FR2 is disposed so that the outer peripheral end portion is nonuniform in the inner and outer peripheral direction with respect to the circumferential direction.

That is, the friction material FR2 in which the outer peripheral end portion is an ellipse has a part in which the position of the ellipse of the outer peripheral end portion is at a different distance from the center CT1. In addition, the distance between the outer peripheral end portion of at least one spot in the circumferential direction and the center CT1 of the plate 1A is different from the distance between the outer peripheral end portion at other spots in the circumferential direction and the center CT1 of the plate 1A.

In the friction plate 1₁₃ according to the thirteenth embodiment configured in this way, there is an increase in the amount of lubrication oil that is fed to the surface of the friction material FR2 for the amount of difference in the lengths in the inner and outer peripheral direction on the outer peripheral side of the friction material FR2. In addition, there is an increase in the separation force in the axial direction between the friction plate 1₁₃ and the separator plate 2 and between the friction plate 1₁₃ and the end plate 3.

Since other functions and effects are similar to those of the first embodiment, description thereof will be omitted.

### Fourteenth Embodiment

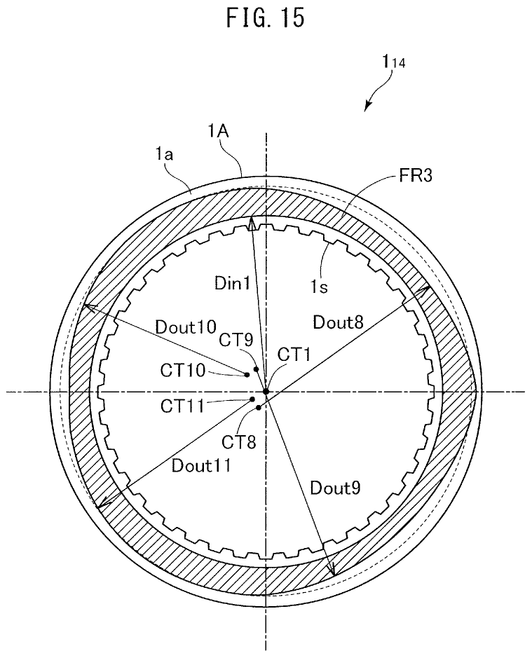

A fourteenth embodiment, which is a partial modification of the first embodiment, will be described with reference to FIG. 15. FIG. 15 is a front view of a friction plate according to the fourteenth embodiment. In the fourteenth embodiment, components that are similar to those in the first embodiment described above are given the same symbols to omit description.

As illustrated in FIG. 15, in a friction plate 1₁₄ according to the fourteenth embodiment, the friction material F is configured of the ring-shaped friction material FR3 that is formed so that the inner peripheral end portion has a circular shape having the center CT1 and the outer peripheral end portion is formed to have a shape in which a plurality of arcs are connected, compared to the first embodiment described above. It is possible to improve durability of the friction material by configuring the friction material F in a ring shape.

In detail, the ring-shaped friction material FR3 is disposed in the friction plate 1₁₄ so that the position of the inner radial end portion is at the position the distance to which from the center CT1 is the radius Din1, and the position of the outer radial end portion is the position at which four arcs are connected. The four arcs are: an arc at the distance of a radius Dout8 from CT8 that is shifted with respect to the center CT1 so as to be offset; an arc at the distance of a radius Dout9 from CT9 that is shifted with respect to the center CT1 so as to be offset; an arc at the distance of a radius Dout10 from CT10 that is shifted with respect to the center CT1 so as to be offset; and an arc at the distance of the radius Dout11 from CT11 that is shifted with respect to the center CT1. The lengths in the inner and outer peripheral direction are different in the outer peripheral end portion with the plurality of different arcs. Thus, the overall friction material FR3 is disposed so that the outer peripheral end portion is nonuniform in the inner and outer peripheral direction with respect to the circumferential direction.

That is, the friction material FR3 in which the outer peripheral end portion is four different arcs that are connected has a part in which the position of the outer peripheral end portion is at a different distance from the center CT1. In addition, the distance between the outer peripheral end portion of at least one spot in the circumferential direction and the center CT1 of the plate 1A is different from the distance between the outer peripheral end portion at other spots in the circumferential direction and the center CT1 of the plate 1A.

In the friction plate 1₁₄ according to the fourteenth embodiment configured in this way, there is an increase in the amount of lubrication oil that is fed to the surface of the friction material FR3 for the amount of difference in the lengths in the inner and outer peripheral direction on the outer peripheral side of the friction material FR3. In addition, there is an increase in the separation force in the axial direction between the friction plate 1₁₄ and the separator plate 2 and between the friction plate 1₁₄ and the end plate 3.

Since other functions and effects are similar to those of the first embodiment, description thereof will be omitted.

### Fifteenth Embodiment

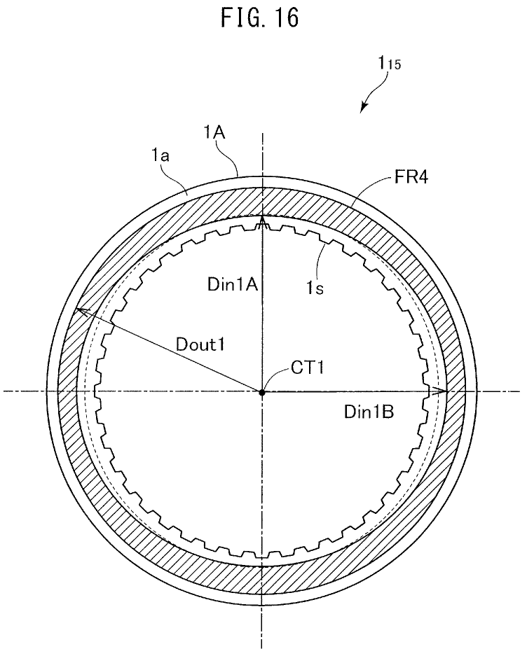

A fifteenth embodiment, which is a partial modification of the first embodiment, will be described with reference to FIG. 16. FIG. 16 is a front view of a friction plate according to the fifteenth embodiment. In the fifteenth embodiment, components that are similar to those in the first embodiment described above are given the same symbols to omit description.

As illustrated in FIG. 16, in a friction plate 1₁₅ according to the fifteenth embodiment, the friction material F is configured of a ring-shaped friction material FR4 in which the outer peripheral end portion is formed with a circle having the center CT1 and the inner peripheral end portion is formed with an ellipse having the center CT, compared to the first embodiment described above. It is possible to improve durability of the friction material by configuring the friction material F in a ring shape.

In detail, in the friction plate 1₁₅, the ring-shaped friction material FR4 is disposed so that the position of the inner radial end portion is at the position of the ellipse in which the short side is a radius Din1A and the long side is a radius Din1B as the distances from the center CT1, and so that the position of the inner radial end portion is at the position the distance to which from the center CT1 is the radius Dout1. Since the inner peripheral end portion has an elliptic shape and the lengths in the inner and outer peripheral direction are different, the overall friction material FR4 is disposed so that the inner peripheral end portion is nonuniform in the inner and outer peripheral direction with respect to the circumferential direction.

That is, the friction material FR4 in which the inner peripheral end portion is an ellipse has a part in which the position of the ellipse of the inner peripheral end portion is at a different distance from the center CT1. In addition, the distance between the inner peripheral end portion of at least one spot in the circumferential direction and the center CT1 of the plate A is different from the distance between the inner peripheral end portion at other spots in the circumferential direction and the center CT1 of the plate 1A.

In the friction plate 1₁₅ according to the fifteenth embodiment configured in this way, there is an increase in the amount of lubrication oil that is fed to the surface of the friction material FR4 for the amount of difference in the lengths in the inner and outer peripheral direction on the inner peripheral side of the friction material FR4. In addition, there is an increase in the separation force in the axial direction between the friction plate 1₁₅ and the separator plate 2 and between the friction plate 1₁₅ and the end plate 3.

Since other functions and effects are similar to those of the first embodiment, description thereof will be omitted.

### Sixteenth Embodiment

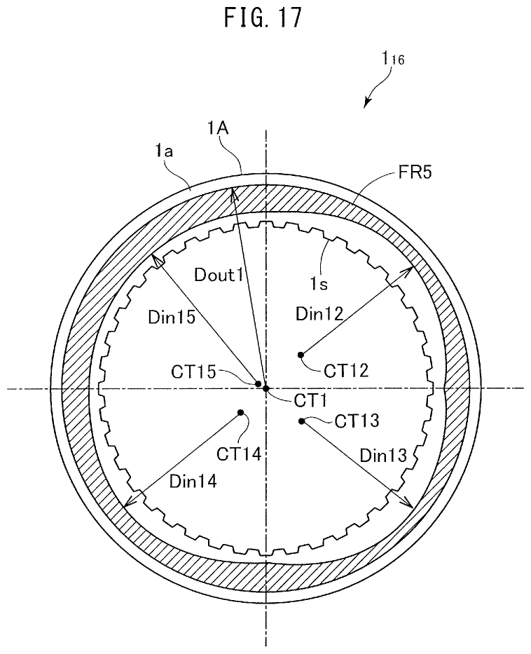

A sixteenth embodiment, which is a partial modification of the first embodiment, will be described with reference to FIG. 17. FIG. 17 is a front view of a friction plate according to the sixteenth embodiment. In the sixteenth embodiment, components that are similar to those in the first embodiment described above are given the same symbols to omit description.

As illustrated in FIG. 17, in a friction plate 1₁₆ according to the sixteenth embodiment, the friction material F is configured of the ring-shaped material FR5 that is formed so that the outer peripheral end portion has a circular shape having the center CT1 and the inner peripheral end portion is formed to have a shape in which a plurality of arcs are connected, compared to the first embodiment described above. It is possible to improve durability of the friction material by configuring the friction material F in a ring shape.

In detail, the ring-shaped friction material FR5 is disposed in the friction plate 1₁₆ so that the position of the outer radial end portion is at the position the distance to which from the center CT1 is the radius Dout1 and so that the position of the inner radial end portion is the position at which four arcs are connected. The four arcs are: an arc in which the radius Din12 is the distance from CT12 that is shifted with respect to the center CT1 so as to be offset; an arc in which the radius Din13 is the distance from a center CT13 that is shifted with respect to the center CT1 so as to be offset; an arc in which the radius Din14 is the distance from a center CT14 that is shifted with respect to the center CT1 so as to be offset; and an arc in which the radius Din15 is the distance from a center CT15 that is shifted with respect to the center CT1. The lengths in the inner and outer peripheral direction are different in the inner peripheral end portion with the plurality of arcs. Thus, the overall friction material FR5 is disposed so that the inner peripheral end portion is nonuniform in the inner and outer peripheral direction with respect to the circumferential direction.

That is, the friction material FR5 in which the inner peripheral end portion is four different arcs that are connected has a part in which the position of the inner peripheral end portion is at a different distance from the center CT1. In addition, the distance between the inner peripheral end portion of at least one spot in the circumferential direction and the center CT1 of the plate 1A is different from the distance between the inner peripheral end portion at other spots in the circumferential direction and the center CT1 of the plate 1A.

In the friction plate 1₁₆ according to the sixteenth embodiment configured in this way, there is an increase in the amount of lubrication oil that is fed to the surface of the friction material FR5 for the amount of difference in the lengths in the inner and outer peripheral direction on the outer peripheral side of the friction material FR5. In addition, there is an increase in the separation force in the axial direction between the friction plate 1₁₆ and the separator plate 2 and between the friction plate 1₁₆ and the end plate 3.

Since other functions and effects are similar to those of the first embodiment, description thereof will be omitted.

### Summary of Embodiments

A friction plate (1) includes (see FIGS. 1 to 17):

a plate (1A) with a disc shape; and

a friction material (F1, F2, F3, F4, FR1, FR2, FR3, FR4, FR5) that is fixed to a side face (1a) of the plate (1A), in which

the friction material is disposed so that one or both of an inner peripheral side and an outer peripheral side are nonuniform in an inner and outer peripheral direction, with respect to a circumferential direction around a center (CT1) of the plate (1A).

In this way, when the oil sump is stirred or when the lubrication oil flowing in from the inner peripheral side is stirred, there is an increase in the amount of lubrication oil that is fed to the surface of the friction material F. In addition, there is an increase in the separation force in the axial direction between the friction plate 1 and the separator plate 2 and between the friction plate 1 and the end plate 3 so that the intervals therebetween can be expanded. It is thus possible to attempt reduction of the drag torque.

A friction plate (1) (see FIGS. 2 to 12) includes:

a plate (1A) with a disc shape; and

a friction material (F1, F2, F3, F4) that is a plurality of friction material segments fixed to a side face (1a) of the plate (1A) and arranged at intervals in a circumferential direction, in which

a distance between an outer peripheral end portion of at least one of the plurality of friction material segments and a center (CT1) of the plate (1A) is different from a distance (Dout1, Dout1₁) between an outer peripheral end portion of another friction material segment and the center (CT1) of the plate (1A) and/or a distance between an inner peripheral end portion of at least one of the plurality of friction material segments and the center (CT1) of the plate (1A) is different from a distance (Din1, Din1₁) between an inner peripheral end portion of another friction material segment and the center (CT1) of the plate (1A).

In this way, when the oil sump is stirred or when the lubrication oil flowing in from the inner peripheral side is stirred, there is an increase in the amount of lubrication oil that is fed to the surface of the friction material F. In addition, there is an increase in the separation force in the axial direction between the friction plate 1 and the separator plate 2 and between the friction plate 1 and the end plate 3 so that the intervals therebetween can be expanded. It is thus possible to attempt reduction of the drag torque.

In the friction plate (1) (see FIGS. 2 to 12),

the friction material is a plurality of friction material segments (F1, F2, F3, F4) that are arranged at intervals in the circumferential direction.

In this way, when the braking device 10 is released, the lubrication oil that enters the interval between the friction material segments goes over the surface of the friction material F, and there is an increase in the separation force in the axial direction. It is thus possible to attempt reduction of the drag torque.

In the friction plate (1) (see FIGS. 4 to 7),

each of the plurality of friction material segments (F1) has the same width (W1) in a direction intersecting with the circumferential direction, and is fixed to the side face (1a) of the plate (1A) at a first position (P1) that is at a first distance (Din3) from the center (CT1) and a second position (P2) that is at a second distance (Din) from the center (CT1), the second distance (Din1) being shorter than the first distance (Din3).

In this way, the overall friction material F can be disposed so that the inner peripheral end portion and the outer peripheral end portion are nonuniform in the inner and outer peripheral direction with respect to the circumferential direction.

In the friction plate (1) (see FIGS. 5 to 7),

the first position (P1) and the second position (P2) are disposed alternately with respect to the circumferential direction.

In this way, the surface area of the friction material F is made uniform in the circumferential direction and when the braking device 10 is engaged, the engagement torque is made uniform. It is thus possible to attempt prevention of the torque variation.

In the friction plate (1) (see FIG. 6), in which

a friction material segment (F1) that is fixed at the first position (P1) has a curvature of an outer peripheral corner portion (Rout2) that is larger than a curvature of an outer peripheral corner portion (Rout1) of a friction material segment that is fixed at the second position (P1).

In this way, the lubrication oil that collides with the outer peripheral corner portion Rout1 now goes over smoothly. It is possible to improve the durability of the friction material segment F1 at the first position P1, decrease the shearing resistance of the lubrication oil, and attempt reduction of the drag torque.

In the friction plate (1) (see FIG. 7),

the friction material segment (F1) that is fixed at the second position (P2) has a curvature of an inner peripheral corner portion (Rin2) that is larger than a curvature of an inner peripheral corner portion (Rin1) of the friction material segment that is fixed at the first position (P1).

In this way, the lubrication oil that collides with the inner peripheral corner portion Rin1 goes over smoothly. It is possible to improve the durability of the friction material segment F1 at the second position P2, decrease the shearing resistance of the lubrication oil, and attempt reduction of the drag torque.

In the friction plate (1) (see FIGS. 2 and 3, FIGS. 8 and 9),

the plurality of friction material segments include a first friction material segment (F1 in FIGS. 2, 3, and 3, F4 in FIG. 9) a width of which in a direction intersecting with the circumferential direction is a first width (W1 in FIGS. 2, 3, and 8, W4 in FIG. 9), and a second friction material segment (F2 in FIGS. 2 and 3, F3 in FIG. 8, F1 in FIG. 9) a width of which in the direction intersecting with the circumferential direction is a second width (W2 in FIGS. 2 and 3, W3 in FIG. 8, W1 in FIG. 1) that is shorter than the first width.

In this way, the overall friction material F can be disposed so that one or both of the inner peripheral end portion and the outer peripheral end portion are nonuniform in the inner and outer peripheral direction with respect to the circumferential direction.

In the friction plate (1) (see FIG. 3, FIGS. 8 and 9),

the first friction material segment (F1 in FIGS. 3 and 8, F4 in FIG. 9) and the second friction material segment (F2 in FIG. 3, F3 in FIG. 8, F1 in FIG. 9) are disposed alternately with respect to the circumferential direction.

In this way, the surface area of the friction material F is made uniform in the circumferential direction and when the braking device 10 is engaged, the engagement torque is made uniform. It is thus possible to attempt prevention of the torque variation.

In the friction plate (1) (see FIG. 8),

an inner peripheral end portion of the first friction material segment (F1) and an inner peripheral end portion of the second friction material segment (F3) are disposed on the same circumference around the center (CT1) of the plate (1A).

In this way, the overall friction material F can be disposed so that the outer peripheral end portion is nonuniform in the inner and outer peripheral direction with respect to the circumferential direction.

In the friction plate (1) (see FIG. 9),

an outer peripheral end portion of the first friction material segment (F4) and an outer peripheral end portion of the second friction material segment (F1) are disposed on the same circumference around the center (CT1) of the plate (1A).

In this way, the overall friction material F can be disposed so that the inner peripheral end portion is nonuniform in the inner and outer peripheral direction with respect to the circumferential direction.

In a friction plate (1) (see FIGS. 10 and 11),

the center of the plate (1A) is a first center (CT1), and

at least one of the plurality of friction material segments is disposed on a circumference around a second center (CT2, CT3, CT4, CT5) at a position that is different from the first center (CT1).

In this way, the overall friction material F can be disposed so that one or both of the inner peripheral end portion and the outer peripheral end portion are nonuniform in the inner and outer peripheral direction with respect to the circumferential direction.

In the friction plate (1) (see FIG. 11),

there is a plurality of the second centers (CT2, CT3, CT4, CT5).

In this way, the overall friction material F can be disposed so that one or both of the inner peripheral end portion and the outer peripheral end portion are further nonuniform in the inner and outer peripheral direction with respect to the circumferential direction.

In the friction plate (1) (see FIG. 12),

the center of the plate (1A) is a first center (CT1), and

at least one of the plurality of friction material segments is disposed on a circumference around a third center (CT6) at a position that is different from the first center (CT1), and a radiating direction is inclined with respect to a radiating direction of the first center (CT1).

In this way, the overall friction material F can be disposed so that one or both of the inner peripheral end portion and the outer peripheral end portion are further nonuniform in the inner and outer peripheral direction with respect to the circumferential direction.

The friction plate (1) (see FIGS. 13 to 16) includes:

a plate (1A) with a disc shape; and

a friction material (FR1, FR2, FR3, FR4, FR5) having a ring shape is fixed to a side face (1a) of the plate (1A) and is continuous in a circumferential direction, in which

a distance between an outer peripheral end portion of the friction material (FR1, FR2, FR3, FR4, FR5) at at least one spot in the circumferential direction and a center (CT1) of the plate (1A) is different from a distance between an outer peripheral end portion of the friction material (FR1, FR2, FR3, FR4, FR5) at another spot in the circumferential direction and the center (CT1) of the plate (1A), and/or a distance between an inner peripheral end portion of the friction material (FR1, FR2, FR3, FR4, FR5) at at least one spot in the circumferential direction is different from a distance between an inner peripheral end portion of the friction material (FR1, FR2, FR3, FR4, FR5) at another spot in the circumferential direction and the center (CT1) of a plate (1A).

In this way, when the oil sump is stirred or when the lubrication oil flowing in from the inner peripheral side is stirred, there is an increase in the amount of lubrication oil that is fed to the surface of the friction material F. In addition, there is an increase in the separation force in the axial direction between the friction plate 1 and the separator plate 2 and between the friction plate 1 and the end plate 3 so that the intervals therebetween can be expanded. It is thus possible to attempt reduction of the drag torque.

The friction plate (1) (see FIGS. 13 to 16) includes:

the friction material is a friction material (FR1, FR2, FR3, FR4, FR5) having a ring shape and is continuous in the circumferential direction.

In this way, the durability of the friction material can be improved.

In the friction plate (1) (see FIG. 13),

the center of the plate (1A) is a first center (CT1), and

the friction material (FR1) having a ring shape has a width that is uniform in the direction intersecting with the circumferential direction, and is disposed on a circumference around a fourth center (CT7) at a position that is different from the first center (CT1).

In this way, the overall friction material F can be disposed so that one or both of the inner peripheral end portion and the outer peripheral end portion are further nonuniform in the inner and outer peripheral direction with respect to the circumferential direction.

In a friction plate (1) (see FIGS. 14 to 17),

the friction material (FR2, FR3, FR4, FR5) having a ring shape has a width that is nonuniform in a direction intersecting with the circumferential direction.

In this way, the overall friction material F can be disposed so that one or both of the inner peripheral end portion and the outer peripheral end portion are further nonuniform in the inner and outer peripheral direction with respect to the circumferential direction.

In the friction plate (1) (see FIG. 14),

an outer peripheral end portion of the friction material (FR2) having a ring shape has an elliptic shape.

In this way, the overall friction material F can be disposed so that the outer peripheral end portion is further nonuniform in the inner and outer peripheral direction with respect to the circumferential direction.

In the friction plate (1) (see FIG. 15),

an outer peripheral end portion of the friction material (FR3) having a ring shape has a shape in which a plurality of arcs with different radii are connected.

In this way, the overall friction material F can be disposed so that the outer peripheral end portion is further nonuniform in the inner and outer peripheral direction with respect to the circumferential direction.

In the friction plate (1) (see FIG. 16),

an inner peripheral end portion of the friction material (FR4) having a ring shape has an elliptic shape.

In this way, the overall friction material F can be disposed so that the inner peripheral end portion is further nonuniform in the inner and outer peripheral direction with respect to the circumferential direction.

In the friction plate (1) (see FIG. 17),

an inner peripheral end portion of the friction material (FR5) having a ring shape has a shape in which a plurality of arcs with different radii are connected.

In this way, the overall friction material F can be disposed so that the inner peripheral end portion is further nonuniform in the inner and outer peripheral direction with respect to the circumferential direction.

In the friction plate (1),

a part of the plate (1A) with a disc shape is immersed in an oil sump.

In this way, when the oil sump is stirred, there is an increase in the amount of lubrication oil that is fed to the surface of the friction material F. In addition, there is an increase in the separation force in the axial direction between the friction plate 1 and the separator plate 2 and between the friction plate 1 and the end plate 3 so that the intervals therebetween can be expanded. It is thus possible to attempt reduction of the drag torque.

A friction engagement device (10) (see FIG. 1) includes:

the friction plate (1); and

a hydraulic servo (20) that is configured to press the friction plate (1).

Thus, a friction engagement device in which it is possible to attempt reduction of a drag torque can be provided.

In the friction engagement device (10) (see FIG. 1),

the friction plate is a plurality of inner friction plates (1) spline-engaged with a rotary member (40) that is configured to rotate,

the friction engagement device (10) includes a plurality of outer friction plates (2, 3) that is disposed alternately in an axial direction with the plurality of inner friction plates (1) and that is spline-engaged with a fixed member (30) that is unrotatable, and

the friction engagement device is a braking device that locks the rotary member (40) to the fixed member (30) so as not to rotate, with the plurality of inner friction plates (1) and the plurality of outer friction plates (2, 3) being pressed by the hydraulic servo (20).

Thus, a braking device in which it is possible to attempt reduction of a drag torque can be provided.

### Other Possible Embodiments

The embodiments above describe configurations in which the friction plate 1 is used as an inner friction plate of the braking device. However, the configuration is not limited to this. The friction plate 1 may be used as an outer friction plate or may be used as an inner friction plate or an outer friction plate of a clutch device. The embodiments above describe configurations in which the friction material F is stuck to the friction plate 1. However, the friction material F may be stuck to the separator plate 2 or the end plate 3, or the friction material may be stuck to all of the friction plate 1, the separator plate 2, and the end plate 3.

In the first to eleventh embodiments, a configuration is described in which the friction material F is configured of any of the friction material segments F1 to F4 that have a generally rectangular shape. However, the shape of the friction material segment may be configured of any shape, as long as the friction material F is nonuniform in the inner and outer peripheral direction with respect to the circumferential direction.

In the twelfth to sixteenth embodiments, a configuration is described in which the friction material is a ring-shaped friction material. However, the ring-shaped friction material may be configured by continuously connecting separate friction materials without intervals to stick the friction material to the separator plate 2 and the end plate 3.

The shape of the friction material F indicated in the first to sixteenth embodiments may be used in any combination, if the friction materials F of the first to sixteenth embodiments can be combined. For example, the curvature of the corner portion of each friction material segment may be set to any curvature. When the friction material segments are arranged in the circumferential direction, the inner peripheral side and the outer peripheral side may be formed to have an elliptic shape or a shape in which a plurality of arcs are connected.

### INDUSTRIAL APPLICABILITY

The friction plate can be used for a friction engagement device that performs power transmission in a vehicle driving device such as an automatic transmission device and a hybrid driving device. It is especially preferable that the friction plate be used for a friction engagement device in which a drag torque reduction is required.

### DESCRIPTION OF THE REFERENCE NUMERALS

1 . . . Friction plate, inner friction plate (friction plate)
1A . . . Plate
1a . . . Side face
2 . . . Outer friction plate (separator plate)
3 . . . Outer friction plate (end plate)
10 . . . Friction engagement device (braking device)
20 . . . Hydraulic servo
30 . . . Fixed portion (case)
40 . . . Rotary member
CT1 . . . Center, first center
CT2 . . . Second center
CT3 . . . Second center
CT4 . . . Second center
CT5 . . . Second center
CT6 . . . Third center
CT7 . . . Fourth center
Din1 . . . Second distance
Din3 . . . First distance
F . . . Friction material
F1 . . . Friction material segment, first friction material segment (FIGS. 2, 3, and 8), second friction material segment (FIG. 9)
F2 . . . Friction material segment, second friction material segment (FIGS. 2 and 3)
F3 . . . Friction material segment, second friction material segment (FIG. 8)
F4 . . . Friction material segment, first friction material segment (FIG. 9)
FR1 . . . Ring-shaped friction material
FR2 . . . Ring-shaped friction material
FR3 . . . Ring-shaped friction material
FR4 . . . Ring-shaped friction material
FR5 . . . Ring-shaped friction material
P1 . . . First position
P2 . . . Second position
Rout1 . . . Outer peripheral corner portion
Rout2 . . . Outer peripheral corner portion
Rin1 . . . Inner peripheral corner portion
Rin2 . . . Inner peripheral corner portion
W1 . . . First width (FIGS. 2, 3, and 8), second width (FIG. 9)
W2 . . . Second width (FIGS. 2 and 3)
W3 . . . Second width (FIG. 8)
W4 . . . First width (FIG. 9)

1. A friction plate comprising:
a plate with a disc shape; and
a friction material that is fixed to a side face of the plate, wherein
the friction material is disposed so that one or both of an inner peripheral side and an outer peripheral side are nonuniform in an inner and outer peripheral direction, with respect to a circumferential direction around a center of the plate set.

2. A friction plate comprising:
a plate with a disc shape; and
a friction material that is a plurality of friction material segments fixed to a side face of the plate and arranged at intervals in a circumferential direction, wherein
a distance between an outer peripheral end portion of at least one of the plurality of friction material segments and a center of the plate is different from a distance between an outer peripheral end portion of another friction material segment and the center of the plate and/or a distance between an inner peripheral end portion of at least one of the plurality of friction material segments and the center of the plate is different from a distance between an inner peripheral end portion of another friction material segment and the center of the plate.

3. The friction plate according to claim 1, wherein the friction material is a plurality of friction material segments that are arranged at intervals in the circumferential direction.

4. The friction plate according to claim 2, wherein each of the plurality of friction material segments has the same width in a direction intersecting with the circumferential direction, and is fixed to the side face of the plate at a first position that is at a first distance from the center and a second position that is at a second distance from the center, the second distance being shorter than the first distance.

5. The friction plate according to claim 4, wherein the first position and the second position are disposed alternately with respect to the circumferential direction.

6. The friction plate according to claim 4, wherein the friction material segment that is fixed at the first position has a curvature of an outer peripheral corner portion that is larger than a curvature of an outer peripheral corner portion of the friction material segment that is fixed at the second position.

7. The friction plate according to claim 4, wherein the friction material segment that is fixed at the second position has a curvature of an inner peripheral corner portion that is larger than a curvature of an inner peripheral corner portion of the friction material segment that is fixed at the first position.

8. The friction plate according to claim 2, wherein the plurality of friction material segments include a first friction material segment a width of which in a direction intersecting with the circumferential direction is a first width, and a second friction material segment a width of which in the direction intersecting with the circumferential direction is a second width that is shorter than the first width.

9. The friction plate according to claim 8, wherein the first friction material segment and the second friction material segment are disposed alternately with respect to the circumferential direction.

10. The friction plate according to claim 8, wherein an inner peripheral end portion of the first friction material segment and an inner peripheral end portion of the second friction material segment are disposed on the same circumference around the center of the plate.

11. The friction plate according to claim 8, wherein an outer peripheral end portion of the first friction material segment and an outer peripheral end portion of the second friction material segment are disposed on the same circumference around the center of the plate.

12. The friction plate according to claim 2, wherein
the center of the plate is a first center, and
at least one of the plurality of friction material segments is disposed on a circumference around a second center at a position that is different from the first center.

13. The friction plate according to claim 12, wherein there is a plurality of the second centers.

14. The friction plate according to claim 2, wherein
the center of the plate is a first center, and
at least one of the plurality of friction material segments is disposed on a circumference around a third center at a position that is different from the first center, the circumference, a radiating direction of which is inclined with respect to a radiating direction of the first center.

15. A friction plate comprising:
a plate with a disc shape; and
a friction material having a ring shape is fixed to a side face of the plate and is continuous in a circumferential direction, wherein
a distance between an outer peripheral end portion of the friction material at at least one spot in the circumferential direction and a center of the plate is different from a distance between an outer peripheral end portion of the friction material at another spot in the circumferential direction and the center of the plate, and/or a distance between an inner peripheral end portion of the friction material at at least one spot in the circumferential direction is different from a distance between an inner peripheral end portion of the friction material at another spot in the circumferential direction and the center of a plate.

16. The friction plate according to claim 1, wherein the friction material is a friction material having a ring shape and is continuous in the circumferential direction.

17. The friction plate according to claim 15, wherein
the center of the plate is a first center, and
the friction material having a ring shape has a width that is uniform in a direction intersecting with the circumferential direction, and is disposed on a circumference around a fourth center at a position that is different from the first center.

18. The friction plate according to claim 15, wherein the friction material having a ring shape has a width that is nonuniform in the direction intersecting with the circumferential direction.

19. The friction plate according to claim 18, wherein an outer peripheral end portion of the friction material having a ring shape has an elliptic shape.

20. The friction plate according to claim 18, wherein an outer peripheral end portion of the friction material having a ring shape has a shape in which a plurality of arcs with different radii are connected.

21. The friction plate according to claim 18, wherein an inner peripheral end portion of the friction material having a ring shape has an elliptic shape.

22. The friction plate according to claim 18, wherein an inner peripheral end portion of the friction material having a ring shape has a shape in which a plurality of arcs with different radii are connected.

23. The friction plate according to claim 1, wherein a part of the plate with a disc shape is immersed in an oil sump.

24. A friction engagement device comprising:
the friction plate according to claim 1; and
a hydraulic servo that is configured to press the friction plate.

25. The friction engagement device according to claim 24, wherein
the friction plate is a plurality of inner friction plates spline-engaged with a rotary member that is configured to rotate,
the friction engagement device includes a plurality of outer friction plates that is disposed alternately in an axial direction with the plurality of inner friction plates and that is spline-engaged with a fixed member that is unrotatable, and
the friction engagement device is a braking device that locks the rotary member to the fixed member so as not to rotate, with the plurality of inner friction plates and the plurality of outer friction plates being pressed by the hydraulic servo.
